(19) United States
(12) Patent Application Publication
(10) Pub. No.: US 2011/0214319 A1
(43) Pub. Date: Sep. 8, 2011

(54) ELECTRONIC GREETING CARDS

(75) Inventor: CHUN CHIEH HSU, TAIPEI HSIEN (TW)

(73) Assignee: CRS ELECTRONIC CO., LTD., TAIPEI HSIEN (TW)

(21) Appl. No.: 12/719,186

(22) Filed: Mar. 8, 2010

(51) Int. Cl. G09F 1/04; G09F 1/00; H01R 12/00

(52) U.S. Cl. 40/124.09; 40/124.01; 439/65

(57) ABSTRACT

The present invention is to provide an improved electronic greeting card, which includes an automatic power-on device that can play pre-recorded message of the sender as soon as it is opened to surprise the receiver of the card. It also includes a slidable USB connector, which provides facilitates for users in transferring or re-recording digital data from/to the electronic greeting card.

### BACKGROUND OF THE INVENTION

There are several kinds of electronic greeting cards have been provided, which usually include a panel with a digital player received in a greeting card, such as US application number 2008/0289230. Digital files are loaded on the player by a connection to a network or from a data storage device with a port. In use, pre-recorded digital content must be pre-recorded on the data storage device or selected for purchase and downloaded or transferred replay by the player of the greeting card. A drawback is that the greeting card is off usually. When user opens the card, he will not get surprise immediately but will be trouble to find how to read the file in the card. On the other hand, transferred or re-recorded digital data from/to the greeting card will be not easy since the connecting port is fixed at a side of the card. If one has no connecting wire, he can not complete the work. The known devices are still lack of utilization.

### SUMMARY OF THE INVENTION

The present invention is to provide an improved electronic greeting card, which provides a solution to overcome the said drawbacks of traditional ones. The improved greeting card will be automatic power-on as soon as it is opened to surprise the receiver of the card. It also includes a slidable USB connector, which provides facilitates for users in transferring or re-recording digital data. The structures of the present invention will be described hereafter by referring to the following drawings.

### BRIEF DESCRIPTION OF THE DRAWINGS

FIG. 1 is a perspective view of an electronic greeting card according to the present invention.

FIG. 2 is another perspective view of an electronic greeting card according to the present invention.

FIG. 3 is a cross-sectional view showing a part of the greeting card in closed state of the present invention.

FIG. 4 is a cross-sectional plan view showing a part of the greeting card in opened state relating to FIG. 3.

### DETAILED DESCRIPTION OF THE PREFERRED EMBODIMENT

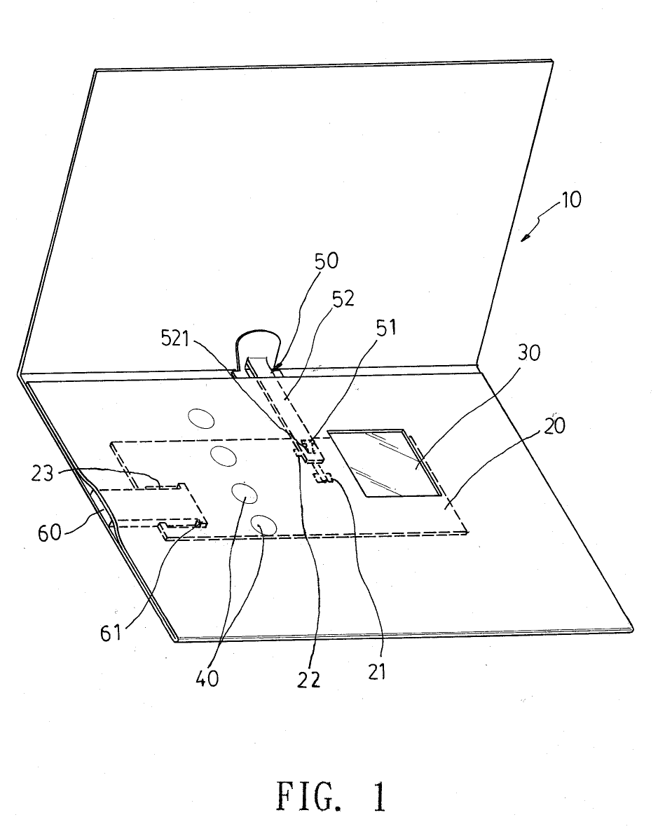

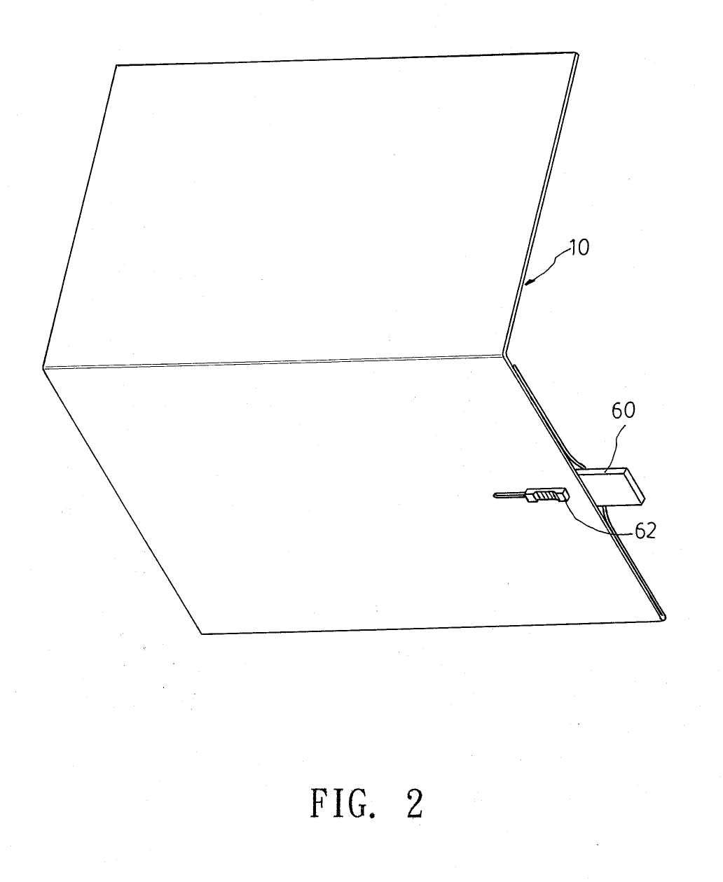

Please refer to FIGS. 1 and 2. The present invention relates to an improvement of an electronic greeting card (10), which includes an inside printed circuit board (20), a TFT or LCD panel (30), and several control buttons (40). An auto-control device (50), including an elastic metal piece (51) and an isolated slice (52), and a slidable USB connector (60) are provided in the greeting card (10). The elastic metal piece (51) has one end to connect with a metal portion (21) on the printed circuit board (20) and the isolated slice (52) has one end fixed on a folded line of the greeting card (10) and the other end provided with an opening (521), in which the free end of the metal piece (51) can pass through from bottom side of the isolated slice (52).

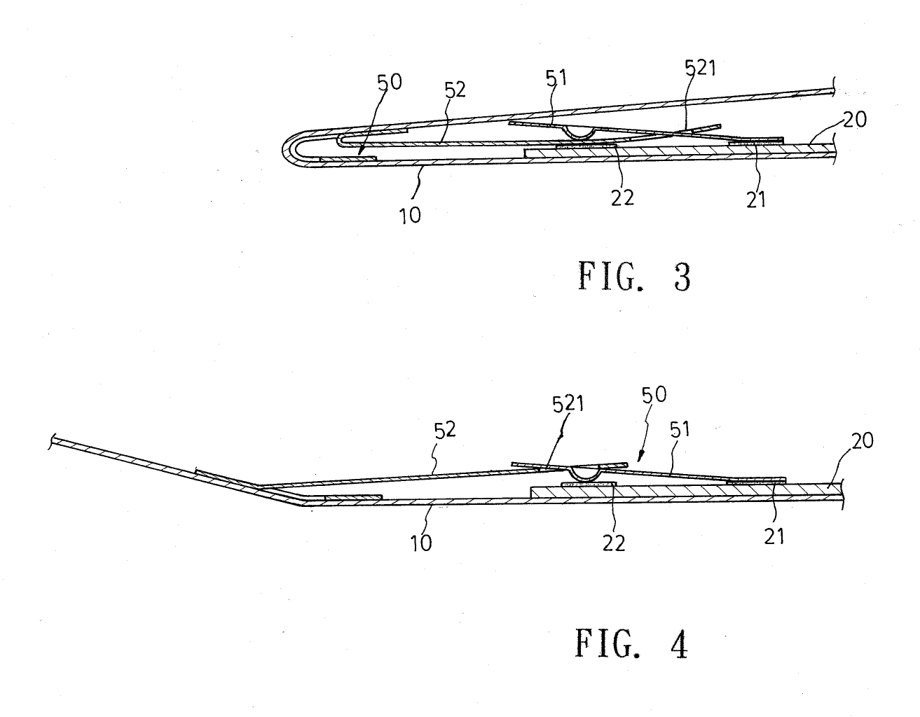

Referring to FIG. 3 and 4, it can be seen that the printed circuit board (20) is provide with two separated metal portion (21), (22), both of which can be connected by the metal piece (51). When the greeting card (10) is closed or folded (FIG. 3), the isolated slice (52) is placed between the metal piece (51) and the metal portions (21), (22). Hence, the electric circuit is not connected and the system of the greeting card is off. As the card is opened as in FIG. 4, the isolated slice (52) moves away and the metal piece (51) becomes a connection of two metal portions (21), (22) that completes a working circuit of the electronic greeting card. It means that the pre-recorded digital data will be played on the panel (30) as soon as the card (10) is opened that will become a real surprise. This is better than ever before.

Further, the USB connector (60) electrically connected with the printed circuit board (20) has inner end provided with a pair of protrusions (61) received in a slot (23) on the printed circuit board (20). A moving button (62) is formed at back side of the USB connector (60) and is exposed from the greeting card (10) as showing in FIG. 2. Accordingly, it is to be understood that the USB connector (60) is capable of being moved outward to connect with a computer or other devices that will be easy for users to transfer or re-record digital data in the greeting card.

Therefore, the present invention obviously obtains improvement and facilitates. And it is to be understood that any modified design according to the merit of the present invention will be still claimed in this application.

I claim:

1. An improved electronic greeting card including an inside printed circuit board, a TFT or LCD panel, and several control buttons, characteristics are in that
an auto-control device, including an elastic metal piece and an isolated slice, and a slidable USB connector being provided in the greeting card.

2. An improved electronic greeting card as claimed in claim 1, wherein the elastic metal piece having one end to connect with a pair of metal portions on the printed circuit board and the isolated slice having one end fixed on a folded line of the greeting card and the other end provided with an opening, in which the free end of the metal piece can pass through from bottom side of the isolated slice.

3. An improved electronic greeting card as claimed in claim 1, wherein the USB connector electrically connected with the printed circuit board having inner end provided with a pair of protrusions received in a slot on the printed circuit board and a moving button being formed at back side of the USB connector and exposed from the greeting card.
